(19) United States
(12) Patent Application Publication
(10) Pub. No.: US 2018/0179418 A1
(43) Pub. Date: Jun. 28, 2018

(54) ADHERING SEALING MEMBRANES ONTO ELECTRICALLY CONDUCTIVE SUBSTRATES BY MEANS OF INDUCTION

(71) Applicant: SIKA TECHNOLOGY AG, Baar (CH)

(72) Inventors: Matthias GÖSSI, Uster (CH); Stefan KEISER, Schwarzenberg (CH); Josef LUSSI, Kerns (CH)

(73) Assignee: SIKA TECHNOLOGY AG, Baar (CH)

(21) Appl. No.: 15/551,585

(22) PCT Filed: Mar. 2, 2016
(86) PCT No.: PCT/EP2016/054476

§ 371 Date: Dec. 14, 2017

(30) Foreign Application Priority Data
Mar. 4, 2015 (EP) 15157504.0

(51) Int. Cl. C09J 5/06; C09J 7/24; C09J 7/35; C09J 5/08; C08J 9/10; B32B 37/06; B32B 37/12; B32B 15/08

(52) U.S. Cl. CPC C09J 5/06; E04D 5/10; C09J 7/35; C09J 5/08; C08J 9/103; B32B 37/06; B32B 37/1207; B32B 15/08; C09J 2427/006; C09J 2431/00; C09J 2205/102; C09J 2205/31; C08J 2203/04; C08J 2207/02; C08J 2331/04; C09J 7/245

(57) ABSTRACT

A method for sealing a substrate having one or a number of electrically conductive surface regions, including the (i) arranging of a sealing membrane, having a plastic layer and an outer adhesive layer made of a melt adhesive, on the substrate, wherein the adhesive layer is facing towards the substrate, (ii) the positioning of an induction heating device over the sealing membrane, and (iii) heating the melt adhesive for the fusion or partial melting thereof by means of the inductive heating of the electrically conductive surface regions with the induction heating device, in order to adhere the sealing membrane to the substrate after cooling. The method facilitates the sealing of substrates with sealing membranes. Same is suitable, in particular, for sealing floors or ceilings or parts thereof.

### TECHNICAL FIELD

The invention relates to the field of sealing, by sealing membranes, of substrates in particular in the construction sector, e.g. floors or roofs.

### PRIOR ART

Construction and civil engineering use many substrates which require sealing with respect to water, particular examples being concrete structures. These substrates are typically sealed by bitumen sheeting or plastics membranes. However, the viscoelastic behavior of bitumen sheeting, with a broad phase transition at room temperature, means that it can be adversely affected by temperature variations. In contrast, the elastic behavior of elastic plastics membranes is constant over a wide temperature range, and they therefore function successfully as seal even under extreme temperature conditions.

Roof membranes are currently either laid without fixing and secured by weighting, or fixed mechanically at discrete points, or fixed by full-surface adhesive bonding. In the case of membranes fixed by adhesive bonding, a force acting on the material, e.g. wind loading, is distributed over a large area, whereas mechanical fixing results in stress peaks. Fixing by adhesive bonding moreover does not penetrate the membrane.

On the other hand, fixing by full-surface adhesive bonding requires that the membrane be rolled up again after it has been positioned, and also requires that an additional adhesive is applied.

Another approach to the fastening of sealing membranes is the commercially available RhinoBond system. The RhinoBond system represents a mixture of membrane fixed mechanically and membrane fixed by inductive adhesive bonding at discrete points. This method uses metal plates on which a hotmelt adhesive has been applied, fixed on the substrate to be sealed. It is advantageous that no penetration of the membrane is necessary. Furthermore, the sealing membrane requires no adhesive layer, because the adhesive has already been applied on the RhinoBond plate. However, fixing at discrete points is still disadvantageous.

In the methods used for fixing by full-surface adhesive bonding, with adhesive applied in advance on the membrane, the practical procedure currently involved use of a gas flame for thermal “activation” (melting) of the adhesive or, if a pressure-sensitive adhesive (PSA) is employed, peeling of a release film. However, again both techniques require that the membrane be rolled up after it has been positioned.

Examples of direct heating of a hotmelt adhesive layer for purposes of fixing by adhesive bonding are found by way of example in EP 2 662 213 A1 and EP 2 428 537 A1, which disclose sealing membranes with a partitioning layer and an adhesive layer, where the adhesive layer comprises an EVA copolymer and azodicarbonamide and, respectively, a solid epoxy resin layer. Procedures mentioned for the activation of the adhesive layer are by way of example treatment of the hotmelt adhesive layer by hot air, flame application, ultrasound or induction welding, the intention here being to introduce the energy into the intervening space between substrate and membrane. This requires that the membrane be lifted from the substrate. EP 2 662 213 A1 moreover proposes indirect heating by hot air or flame application, but this requires firstly a membrane material with adequate heat resistance and secondly introduction of a relatively large amount of heat.

### DESCRIPTION OF THE INVENTION

It is therefore an object of the present invention to provide a sealing system which does not have the disadvantages of the prior art. A particular intention is that production and application of the sealing system can be simple and efficient, and that the system provides a good adhesive bond between sealing membrane and substrate. Another intention is to permit fixing by full-surface adhesive bonding. A further intention is to ensure a high level of waterproofing.

Surprisingly, it has been found that this problem can be solved via inductive adhesive bonding of a sealing membrane to a substrate which has electrically conductive surface regions.

Accordingly, the invention provides a method for the sealing of a substrate which comprises one or more electrically conductive surface regions, comprising

(i) arranging, on the substrate, a sealing membrane which comprises a plastics layer and which comprises an exterior adhesive layer made of a hotmelt adhesive, where the adhesive layer faces toward the substrate,

(ii) placing an induction heater over the sealing membrane and

(iii) heating the hotmelt adhesive, by the induction heater, in order to cause melting or incipient melting via inductive heating of the electrically conductive surface regions so that the sealing membrane is fixed by adhesive bonding to the substrate.

The sealing method of the invention permits rapid and cost-effective sealing of a substrate having electrically conductive surface regions, in particular of a concrete structure having electrically conductive surface regions.

In particular, there is no longer any requirement that the sealing membrane that has already been laid be rolled up again in order to permit heating of the adhesive, as is by way of example necessary in the case of heating by a gas flame; this means that once the membrane has been positioned it is no longer necessary to move it in order to bring about fixing by adhesive bonding. When the word “over” is used in connection with the placing of the induction heater, this means that the induction heater is to be placed on that side of the sealing membrane that faces away from the hotmelt adhesive layer. The direct heating provided by way of the induction heater to the electrically conductive surface regions therefore very substantially avoids any thermal stressing of the sealing membrane, because the electrically conductive surface areas are selectively heated by induction, and the heat can then be directly transferred to the hotmelt adhesive layer. A substantial advantage of this procedure is that when the adhesive becomes molten it is already in contact with the substrate, and there is therefore no longer any need for subsequent movement of the membrane. This facilitates exact placement, and fixing by adhesive bonding, of the membrane.

It becomes considerably easier to fasten the sealing membranes, in particular on roofs, in particular when fine details of cladding operations are carried out manually.

Advantageous fixing by full-surface adhesive bonding can moreover be achieved, because the adhesive coating is present on the reverse side of the membrane, and not on the inductively heated, electrically conductive material.

These materials provided for sealing can moreover also be applied to a substrate without use of an open flame; this is in particular advantageous for safety reasons.

Further aspects of the invention are provided by further independent claims. Particularly preferred embodiments of the invention are provided by the dependent claims.

### BRIEF DESCRIPTION OF THE DRAWING

FIGS. 1 and 2 are diagrams of sealing films suitable for the invention.

FIG. 3 is a diagram showing the heating and melting energy required per unit of the surface area for the superficial adhesive layer amounting to 0.1 mm, for various adhesives.

FIG. 4 is a diagram showing the depth which the electromagnetic field penetrates into various metals, as a function of frequency.

FIG. 5 is a diagram showing the heating time as a function of the power output by the induction heater, for various metals.

### METHODS OF IMPLEMENTATION OF THE INVENTION

The method of the invention bonds the sealing membrane to a substrate which has electrically conductive surface regions.

The material of the substrate is by way of example wood, metal, a metal alloy, a mineral binder such as concrete or gypsum, plastic or thermal insulation such as foamed polyurethane, mineral wool or foamed glass. It is particularly preferable that the material is wood, metal, a metal alloy or concrete, in particular concrete.

The substrate has one or more electrically conductive surface regions. The electrically conductive surface can have been provided to a portion of, or all of, the substrate surface, but it is preferable here that the electrically conductive surface has been provided to all of the substrate surface. If the electrically conductive surface has been provided to a portion of the substrate surface, the regions can by way of example take the form of strips at the margins of the substrate and/or of isolated areas on the substrate distributed in a suitable pattern, or in any desired advantageous pattern.

The electrically conductive surface is generally made of a metal or metal alloy. Preferred examples of a suitable metal are steel, in particular stainless steel, aluminum, brass, copper and zinc.

The electrically conductive surface can by way of example be composed of at least one component selected from metal plates, aluminum foil, sheetmetal, in particular angled sheetmetal, or vapor barriers. Metal plates are used by way of example to fasten insulation in built structures. Aluminum foil can be used as vapor barrier on the insulation.

The substrate can be composed of one component or of a plurality of components, made of the same material or of a different material, where at least one component is electrically conductive. The electrically conductive components can have been arranged, and optionally fixed, on a main body of the substrate, preferably a concrete structure. The substrate is preferably a concrete structure which has one or more electrically conductive surface regions composed of components arranged, and optionally fixed, on the concrete structure. The concrete structure can have further layers applied thereon, e.g. an insulation layer, the location of these then being between the concrete structure and the electrically conductive components. The concrete surface can have been pretreated with an epoxy-resin-based primer.

The substrate is preferably a component, in particular one used in construction or civil engineering. The substrate having one or more electrically conductive surface regions is particularly preferably a floor or a roof, in particular a flat roof, or a component thereof.

The sealing membrane 1 comprises a plastics layer 2, which is also termed partitioning layer, and an exterior adhesive layer 3 made of a hotmelt adhesive. FIG. 1 shows a sealing membrane composed of these two layers. However, the sealing membrane can also comprise further layers and/or reinforcing elements. Materials suitable as plastics layer are in particular films, in particular flexible films. These films are widely used for sealing purposes in the prior art in construction and civil engineering, and are obtainable commercially. These films can easily be rolled. The sealing membrane can therefore easily be unrolled in situ and optionally trimmed to the required dimensions.

The plastics layer is preferably made of a material with softening point above 60° C., preferably in the range from 70 to 150° C., more preferably in the range from 80° C. to 130° C.

The thickness of the plastics layer is preferably from 0.05 to 10 mm, in particular from 1 to 5 mm.

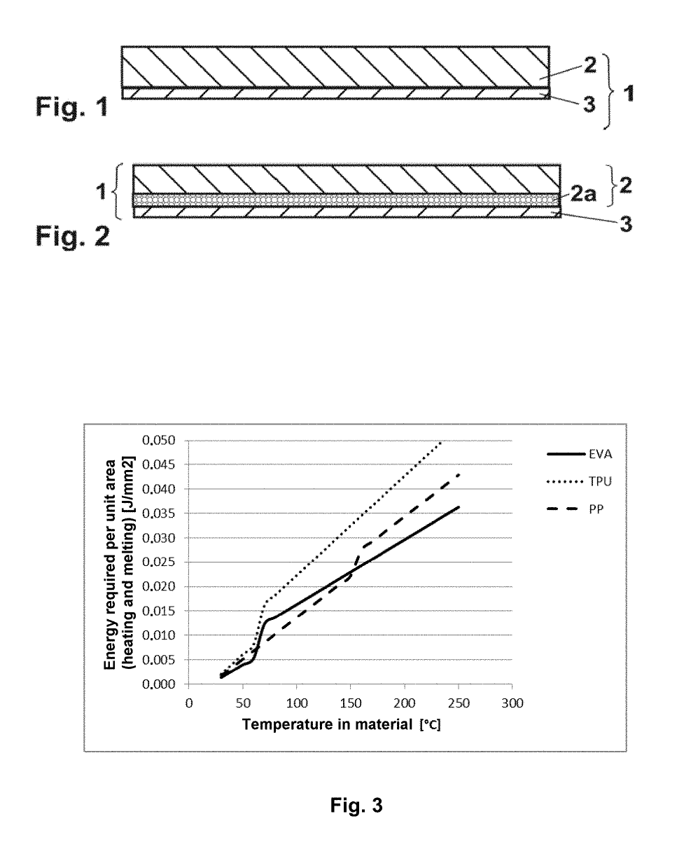

In one embodiment, the plastics layer 2 has, on the side facing toward the adhesive layer 3, a foamed portion 2a. This is shown by way of example in FIG. 2. This is advantageous in that less heat has to be introduced in order to heat the adhesive layer. The thickness of the foamed portion of the plastics layer 2a is further advantageously from 20 to 80% of the total thickness of the plastics layer 2, in particular from 45 to 65%. The density of the foamed portion of the plastics layer is preferably from 200 to 700 kg/m³, in particular from 300 to 500 kg/m³.

The plastics layer preferably comprises at least one thermoplastic polymer. Examples of the thermoplastic polymer are high-density polyethylene (HDPE), medium-density polyethylene (MDPE), low-density polyethylene (LDPE), polyethylene (PE), polypropylene (PP), polyethylene terephthalate (PET), polystyrene (PS), polyvinyl chloride (PVC), polyamides (PA), ethylene-vinyl acetate (EVA), chlorosulphonated polyethylene and thermoplastic elastomers based on polyolefin (TPO), and also mixtures thereof.

It is preferable that the thermoplastic polymer is a thermoplastic polyolefin and/or polyvinyl chloride (PVC). Most preference is given to polyethylene (PE) or a copolymer of ethylene and propylene.

The plastics layer preferably comprises more than 40% by weight, based on the total weight of the plastics layer, of one or more thermoplastic polymers, in particular the preferred thermoplastic polymers listed above.

In one preferred embodiment, the plastics layer comprises from 70 to 100% by weight, in particular from 90 to 100% by weight, based on the total weight of the polymers in the plastics layer, of polyethylene (PE) and/or copolymer of ethylene and propylene.

In another preferred embodiment, the plastics layer comprises polyvinyl chloride, in particular flexible PVC, this material preferably being a flexible polyvinyl chloride sealing film. Flexible PVC comprises in particular plasticizer, typically phthalate plasticizer.

It is clear to a person skilled in the art that the plastics layer can also comprise additives and/or processing aid, e.g. fillers, UV stabilizers and heat stabilizers, plasticizers, lubricants, biocides, flame retardants, antioxidants, pigments, e.g. titanium dioxide or carbon black, and dyes.

The plastics layer can optionally and preferably comprise a supportive layer. The supportive layer contributes to the dimensional stability of the plastics layer. The supportive layer can be composed of fibers or can be a mesh, preference being given to supportive layers made of fibers. The fibers can be organic, inorganic, or synthetic. Examples of organic fibers are cellulose fibers, cotton fibers and protein fibers. Examples of inorganic fibers are glass fibers. Examples of synthetic fibers are fibers made of polyester or made of a homo- or copolymer of ethylene and/or propylene, and of viscose.

The supportive layer made of fibers is by way of example a woven fabric, laid scrim, or knitted fabric, but the supportive layer is preferably a felt or nonwoven fabric.

The supportive layer has preferably been embedded into the plastics layer. The supportive layer advantageously has interstices into which, at least to some extent, the material of the plastics layer has penetrated.

The sealing membrane comprises an exterior adhesive layer made of a hotmelt adhesive. The adhesive layer is arranged on an external side of the sealing membrane. There is preferably direct bonding between the adhesive layer and the plastics layer. The adhesive layer can be present on all of, or a portion of, preferably all of, the surface of the external side of the sealing membrane.

Hotmelt adhesives are solid at room temperature (23° C.), and can be melted, or incipiently melted, by heating. On cooling they become solid again and thus create adhesion to the item to be fixed by adhesive bonding.

The adhesive layer is a hotmelt adhesive layer, i.e. it is solid at room temperature (23° C.). It is preferable that the adhesive layer is tack-free at 23° C. The term “tack-free” here means that the level of immediate adhesion or tack is so low at 23° C. that when a thumb is pressed onto the surface of the adhesive layer, exerting a force of about 5 kg for 1 second, the thumb does not stick to the surface of the adhesive layer and, respectively, the adhesive layer cannot be lifted. This facilitates storage, transport and use of the material provided for sealing. In particular, movement on the substrate for placement purposes is also possible.

The hotmelt adhesive is not subject to any particular requirements, but it can be advantageous to use, as hotmelt adhesive, a hotmelt adhesive based on ethylene-vinyl acetate (EVA), i.e. with ethylene-vinyl acetate as substantial functional constituent. The softening point of the hotmelt adhesive is moreover advantageously below the softening point of the plastic of the plastics layer, and in particular at least about 10 Kelvin below the softening point of the plastic of the plastics layer, because otherwise the membrane can be damaged during heating.

The softening point is measured here by the ring and ball method, e.g. by a method based on DIN EN 1238.

The thickness of the hotmelt adhesive applied and, respectively, the thickness of the adhesive layer is preferably about 0.01 to 5 mm, with preference about 0.05 to 2 mm, and with most preference about 0.1 to 1 mm.

The hotmelt adhesive of the adhesive layer can be an unreactive or reactive hotmelt adhesive, preference being given here to an unreactive hotmelt adhesive.

In one embodiment, the adhesive layer can comprise a chemical blowing agent, in particular azodicarbonamide.

The hotmelt adhesive and, respectively, the adhesive layer preferably comprises at least one polymer selected from ethylene-vinyl acetate (EVA), thermoplastic polyolefin, in particular atactic poly-α-olefin (APAO), polyurethane (PUR), in particular thermoplastic polyurethane (TPU), polyester (PES) or solid epoxy resin, preference being given here to ethylene-vinyl acetate. Another term used for thermoplastic polyurethane is polyurethane-based thermoplastic elastomer.

The hotmelt adhesive and, respectively, the adhesive layer preferably comprises

a) at least one ethylene-vinyl acetate copolymer and optionally a blowing agent, in particular azodicarbonamide, or
b) at least one polymer selected from polyethylene (PE), polypropylene (PP) or a copolymer of ethylene and propylene and at least one polyolefin-based polymer which has at least one functional group selected from carboxylic acids, OH groups, anhydrides, acetates and glycidylmethacrylates, and also optionally a blowing agent, in particular azodicarbonamide, or
c) at least one polyurethane, in particular a polyurethane based on polyester polyol, and/or at least one copolymer from the free-radical polymerization of at least two different monomers which comprise at least one, preferably one, C═C double bond, or
d) at least one thermoplastic poly-α-olefin, in particular an atactic poly-α-olefin (APAO), or
e) at least one solid epoxy resin and optionally at least one thermoplastic polymer.

There can optionally be a barrier layer arranged between the plastics layer and the exterior adhesive layer in the sealing membrane. If by way of example hotmelt adhesive used comprises a composition comprising constituents, for example plasticizers, which migrate into the plastics layer, which is generally impermeable to water, and can impair the functionality thereof, it can be advisable to apply a barrier layer between the coating made of the hotmelt adhesive and the substrate layer that is impermeable to water.

The sealing membrane can optionally advantageously further comprise an outer layer, preferably attached on the plastics layer on the side facing away from the adhesive layer. If the outer layer comprises UV stabilizers, the outer layer can protect the sealing membrane by way of example from aging caused by sunlight. If the outer layer comprises color pigments, damage on that side of the sealing membrane that faces away from the adhesive layer, e.g. caused by transport or by laying, can be discovered via absence of the outer layer at the site of damage.

In certain cases that are not preferred, it can be advisable that a release paper, e.g. a siliconized release paper, is temporarily applied to the adhesive layer before the membrane is rolled; said paper is in turn removed before adhesive bonding. The release paper can serve to avoid blocking during roll-up and transport.

The sealing membrane is typically used in the form of prefabricated web, in particular in the form of a roll. However, it is also possible that the sealing membrane is used in the form of strips of width by way of example from 1 to 20 cm, for example in order to seal connections between two pieces of roof sheeting. It is further possible that the sealing membrane takes the form of, and is used in the form of, flat sections for the repair of sites of damage in sealing systems, for example roof sheeting.

The sealing membrane is arranged on the substrate in the method of the invention, and the exterior adhesive layer faces toward the substrate here. Arrangement of the sealing membrane on the substrate can be achieved by way of example by unrolling of the sealing membrane or laying of the sealing membrane. The sealing membrane is optionally cut to size if necessary. When the adhesive layer is tack-free, the sealing membrane can conveniently be moved or placed on the substrate before heating.

The hotmelt adhesive is then heated to cause melting or incipient melting. The heating is achieved inductively. To this end, an induction heater is placed over the arranged sealing membrane. It is self-evident that the word “over” refers to that side of the sealing membrane that is opposite to the substrate. The induction heater is advantageously placed directly on or only slightly above the sealing membrane, i.e. the distance between induction heater and sealing membrane is preferably less than 10 mm, or induction heater and sealing membrane are in contact with one another.

It is further self-evident that the induction heater is placed so that it is also over an electrically conductive surface region of the substrate. It is further self-evident that after fixing by adhesive bonding at a site the induction heater is continuously or intermittently placed at another site where fixing by adhesive bonding is required, and that the procedure is repeated until all of the regions to be adhesive bonded have thus been heated.

The heating for the melting or incipient melting of the hotmelt adhesive is achieved via inductive heating of the electrically conductive surface regions of the substrate by the induction heater placed over the sealing membrane.

The heating causes melting or incipient melting of the hotmelt adhesive, which after cooling forms an adhesive bond between hotmelt adhesive and substrate or the electrically conductive regions of the substrate. The sealing membrane is thus fixed to the substrate by adhesive bonding.

The temperature to which the hotmelt adhesive and, respectively, the adhesive layer is preferably heated here in order to cause melting or incipient melting is in the range from 60 to 250° C., preferably from 90 to 200° C.

Incipient melting here means the melting of a superficial layer. This means that only a portion of the layer thickness of the hotmelt, from the surface as far as a penetration depth that is not defined with any greater precision, is heated to above the melting point (Tₘ) or softening point of said hotmelt, rather than the entire layer thickness of the hotmelt.

In the method of the invention, the electrically conductive portions or surface regions of the substrate below the sealing membrane are heated by means of an induction heater from above the membrane and, by emitting thermal radiation, melt, incipiently melt, or activate the hotmelt adhesive which is situated thereon and which has been applied in advance to the underside of the membrane. Cooling thus produces an adhesive bond between the membrane and the electrically conductive portion and, respectively, the electrically conductive surface and, respectively, between the membrane and the substrate.

Induction heaters are known to the person skilled in the art and are available commercially. The frequency at which the induction heater is operated is preferably in the range from 10 to 1000 kHz, the power output preferably being at least 1 W; the frequency is more preferably in the range from 50 to 600 kHz, the power output preferably being at least 10 W, and the frequency is most preferably in the range from 50 to 400 kHz, the power output preferably being at least 100 W.

The induction heater is preferably operated with power output at least 1 W, more preferably at least 10 W and particularly preferably at least 100 W.

Higher frequencies can lead to problems in relation to health and safety at work and in relation to the field stability. Lower power values and frequencies considerably reduce throughput rate.

The minimum energy that has to be introduced into the hotmelt adhesive is calculated from the energy required to heat and melt a superficial layer of the adhesive with respect to the electrically conductive surface. The energy required for heating is defined via the specific heat capacity and the melting point or softening point of the adhesive; the energy required for melting is defined via the enthalpy of fusion. The thickness of the superficial layer is assumed hereinafter to be 0.1 mm.

The decomposition temperature of the organic materials in the hotmelt adhesive could place an upper limit on the energy introduced. However, it would be incorrect to limit the power output of the induction heater for this reason, because the excess power output can be “compensated” by using a larger inductor, thus permitting faster operation.

Another factor determining the energy required is the volume of the adhesives to be heated. The sealing membrane predetermines only the thickness of the adhesive layer here. Definition of the volume to be heated also involves the area of the inductor used. The inductor of the induction heater generates the electromagnetic field which heats the electrically conductive components by inducing an “eddy” current.

FIG. 3 shows the minimal energy that has to be introduced per unit area for inductor-design-independent operation. FIG. 3 shows the energy required per unit area for heating and melting of the superficial adhesive layer of 0.1 mm for adhesives comprising EVA-, TPU- or PP-based polymers.

The minimal energy required per unit surface area is preferably at least about 0.015 J/mm². The energy per unit area relates to the energy emitted by the inductor of the induction heater, based on the area of the inductor.

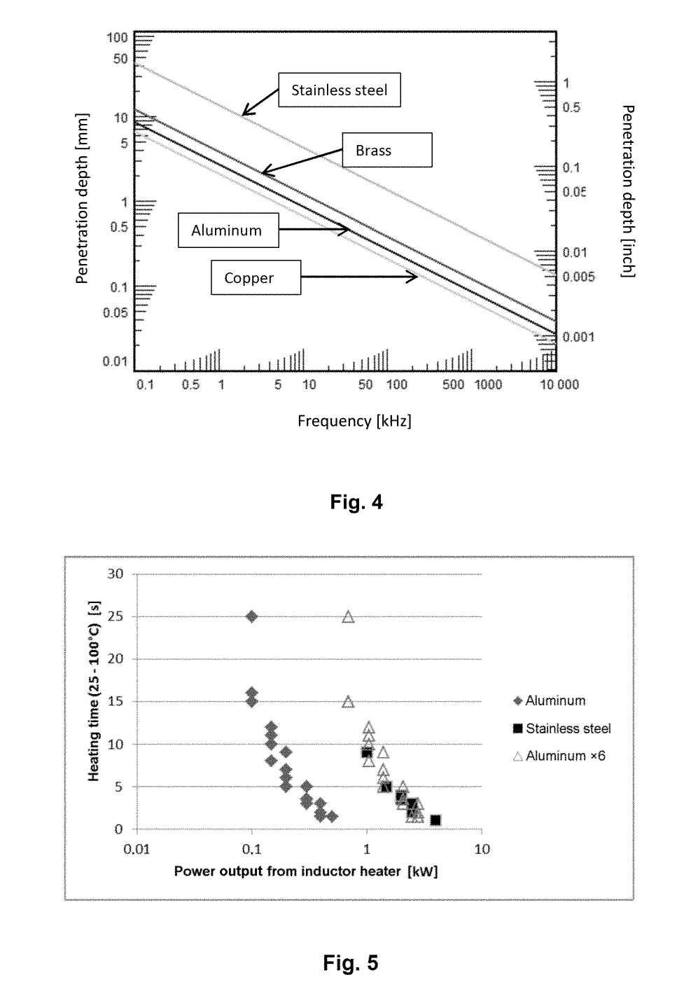

The depth to which the electromagnetic field penetrates into the electrical conductor determines the efficiency of inductive heating. In principle, the penetration depth decreases as conductivity increases. As can be seen from FIG. 4, the penetration depths of aluminum and stainless steel at identical frequency differ by a factor of 5. Penetration depths for copper are even smaller than for aluminum, while brass lies between aluminum and stainless steel.

The energy required to ensure introduction of the minimal energy calculated above for the melting or incipient melting or activation of the adhesive for adhesive bonds on stainless steel is several times that required for bonds on aluminum, because coupling efficiency at identical layer thickness is lower for stainless steel. This has been demonstrated experimentally and is documented by the examples in Table 1 and FIG. 5.

The present invention also provides a substrate sealed by a sealing membrane, obtainable by the method of the invention.

The present invention also provides the use of a sealing membrane which comprises a plastics layer and which comprises an exterior adhesive layer made of a hotmelt adhesive for inductive adhesive bonding to a substrate. To this end, the substrate has metallic surface regions which are optionally attached in advance. A preferred use of the sealing membrane is the use for inductive adhesive bonding to substrates which are components used in construction and in civil engineering, in particular of roofs and floors or of components thereof, where the sealing membrane applied by adhesive bonding in particular provides sealing with respect to moisture.

### Examples

The sealing membrane used for fixing by adhesive bonding was Sikaplan G410-12EL from Sika Schweiz AG, a PVC roof membrane with layer thickness 1.2 mm. An EVA hotmelt adhesive was applied as adhesive layer with layer thickness 0.2 mm on one side of the PVC roof membrane. Substrates used were stainless steel with layer thicknesses of about 30 μm and, respectively, 125 μm and aluminum with layer thicknesses of about 30 μm. The PVC membrane was arranged with the adhesive layer downward on the substrate.

A commercially available induction heater (TNX20, Plustherm Point GmbH, Wettingen (CH)) with inductor area 6900 mm² was then placed on the sealing membrane, and the hotmelt adhesive was thus heated from room temperature (25° C.) to about 100° C. In all cases, cooling gave a full-surface adhesive bond between substrate and sealing membrane. Parameters for implementation of the method are given in Table 1.

TABLE 1

| | Example | | | | | | |
|---|---|---|---|---|---|---|---|
| | 1 | 2 | 3 | 4 | 5 | 6 | 7 |
| | Electrical conductor | | | | | | |
| | Stainless steel | | | | Aluminum | | |
| | Layer thickness [μm] | | | | | | |
| | | | | about | | | |
| | about 30 | | | 125 | about 30 | | |
| Induction parameters | | | | | | | |
| Frequency [kHz] | 100 | 100 | 225 | 100 | 100 | 100 | 225 |
| Power [kW] | 1.5 | 1 | 1 | 1.5 | 0.2 | 0.15 | 0.2 |
| Heating time | | | | | | | |
| 25-100° C. [s] | 5 | 9 | 3 | 2 | 6 | 10 | 3 |
| Energy introduced | | | | | | | |
| Maximal [J/mm²] | 1.1 | 1.3 | 0.43 | 0.43 | 0.14 | 0.17 | 0.09 |
| Required [J/mm²] | 0.017 | 0.017 | 0.017 | 0.017 | 0.017 | 0.017 | 0.017 |
| Efficiency [%] | 1.5 | 1.3 | 3.8 | 3.8 | 12 | 10 | 18 |

Comparison of examples 1 and 2 with examples 5 and 6 shows that the power required to heat the adhesive on stainless steel is increased by a factor of 6 in comparison with aluminum. This corresponds approximately to the difference in penetration depth. FIG. 5 shows the increase of initial induction-heater power by a factor of 6 in order to achieve the same heating rate.

FIG. 5 shows the time measured for heating from 25 to 100° C. for an area of 15×460 mm for the membrane/adhesive combination of examples 1 to 7 for an induction frequency of 100 kHz as a function of initial power. The heating times represented by the unfilled triangles are equal to those represented by the filled rhombuses, but multiplied by 6.

Examples 3 and 7 show that for both electrically conductive materials tested, aluminum and stainless steel, frequency increase leads to reduced heating time and, respectively, to increased heating rate. Example 4 shows that, for identical frequency, a thicker layer of the electrical conductor likewise leads to reduced heating time. Both observations (frequency and conductor layer thickness) are in accordance with the depth to which the electromagnetic field penetrates into the electrical conductor. When frequency is increased, the initial power output is concentrated within a thinner layer, while the thicker layer absorbs more of the initial power output. The efficiency of the inductive heating is thus increased.

As can be seen from the comparison of the energy provided by the induction heater (maximal energy introduced) and the minimal energy (energy introduction required) to heat the plastics layer of thickness 0.1 mm in Table 1, the energy efficiency for thin steel layers is only a few percent, while the efficiency achieved for aluminum was substantially higher: from 10 to 20%. Accordingly, higher efficiency is expected for copper layers than for aluminum, while coupling efficiency of brass will be somewhat lower.

### KEY

1 Sealing membrane
2 Plastics layer
2a Foamed portion of plastics layer
3 Adhesive layer

1. A method for the sealing of a substrate which comprises one or more electrically conductive surface regions, comprising
(i) arranging, on the substrate, a sealing membrane which comprises a plastics layer and which comprises an exterior adhesive layer made of a hotmelt adhesive, where the adhesive layer faces toward the substrate,
(ii) placing an induction heater over the sealing membrane and
(iii) heating the hotmelt adhesive, by the induction heater, in order to cause melting or incipient melting via inductive heating of the electrically conductive surface regions so that, after cooling, the sealing membrane is fixed by adhesive bonding to the substrate.

2. The method as claimed in claim 1, wherein the induction heater is operated at a frequency in the range from 10 to 1000 kHz and/or with a power output of at least 1 W.

3. The method as claimed in claim 1, wherein the hotmelt adhesive is heated to a temperature in the range from 60 to 250° C.

4. The method as claimed in claim 1, wherein an electrically conductive surface has been provided to all of the substrate surface and/or the substrate comprises a concrete structure which has one or more electrically conductive surface regions.

5. The method as claimed in claim 1, wherein the electrically conductive surface regions are composed of at least one component selected from metal plates, aluminum foil, vapor barriers and/or sheet metal.

6. The method as claimed in claim 1, wherein the substrate is a component used in construction or in civil engineering.

7. The method as claimed in claim 1, wherein the adhesive layer is tack-free at 23° C.

8. The method as claimed in claim 1, wherein the adhesive layer comprises at least one polymer selected from ethylene-vinyl acetate (EVA), thermoplastic polyolefin, atactic poly-α-olefin (APAO), polyurethane (PUR), in particular thermoplastic polyurethane (TPU), polyester (PES) or epoxy resin.

9. The method as claimed in claim 1, wherein the adhesive layer comprises a chemical blowing agent.

10. The method as claimed in claim 1, wherein the adhesive layer comprises
a) at least one ethylene-vinyl acetate copolymer and optionally a blowing agent, or
b) at least one polymer selected from polyethylene (PE), polypropylene (PP) or a copolymer of ethylene and propylene and at least one polyolefin-based polymer which has at least one functional group selected from carboxylic acids, OH groups, anhydrides, acetates and glycidylmethacrylates, and also optionally a blowing agent, or
c) at least one polyurethane and/or at least one copolymer from the free-radical polymerization of at least two different monomers which comprise at least one C═C double bond, or
d) at least one thermoplastic poly-α-olefin, or
e) at least one solid epoxy resin and optionally at least one thermoplastic polymer.

11. The method as claimed in claim 1, wherein the plastics layer comprises at least one thermoplastic polymer.

12. The method as claimed in claim 1, wherein the hotmelt adhesive of the adhesive layer is an unreactive or reactive hotmelt adhesive.

13. A substrate sealed by a sealing membrane, obtainable by a method as claimed in claim 1.

14. A sealing membrane which comprises a plastics layer and which comprises an exterior adhesive layer made of a hotmelt adhesive, utilized for the sealing of a substrate by inductive adhesive bonding.
